(19) United States
(12) Patent Application Publication
(10) Pub. No.: US 2019/0227890 A1
(43) Pub. Date: Jul. 25, 2019

(54) INFORMATION PROCESSING APPARATUS, INFORMATION PROCESSING SYSTEM, AND NON-TRANSITORY COMPUTER-READABLE RECORDING MEDIUM HAVING STORED THEREIN CONTROL PROGRAM

(71) Applicant: FUJITSU LIMITED, Kawasaki-shi (JP)

(72) Inventors: Masaki Takeuchi, Kawasaki (JP); Yoshimasa MISHUKU, Yokohama (JP); Yutaro Hiraoka, Kawasaki (JP)

(73) Assignee: FUJITSU LIMITED, Kawasaki-shi (JP)

(21) Appl. No.: 16/222,048

(22) Filed: Dec. 17, 2018

(30) Foreign Application Priority Data
Jan. 22, 2018 (JP) 2018-008422

(51) Int. Cl. G06F 11/20; G06F 11/14; G06F 11/07; G06F 3/06

(52) U.S. Cl. CPC G06F 11/2071; G06F 11/1474; G06F 11/0724; G06F 3/0689; G06F 3/0659; G06F 3/0614; G06F 11/0715

(57) ABSTRACT

An information processing apparatus transmits a task executing request to a first control node to execute a task including multiple processes among multiple control nodes; and stores management information associating the task executing request transmitted to the first control node with a response result received from the first control node. The task executing request includes: a command to execute the task; a command to respond with a first notification indicating normal completion of the plurality of processes; a command to execute, when execution of at least one of the processes fails, a regaining process that regains statuses of one or more remaining processes successfully executed to statuses before being executed; and a command to response, when the regaining process is normally completed, a second notification indicating normal completion of the regaining process. Accordingly, the load on a control node managing multiple control nodes can be reduced.

### CROSS-REFERENCE TO RELATED APPLICATION

This application is based upon and claims the benefit of priority of the prior Japanese Patent application No. 2018-008422, filed on Jan. 22, 2018, the entire contents of which are incorporated herein by reference.

### FIELD

The embodiment discussed herein is directed to an information processing apparatus, an information processing system, and a non-transitory computer-readable recording medium having stored therein a control program.

### BACKGROUND

In recent years, a system called Software Defined Storage (SDS) system provided with multiple computer nodes (hereinafter simply referred to as “nodes”) has been known.

Accompanying drawing FIG. 21 is a diagram schematically illustrating the configuration of a traditional SDS system 500.

In the SDS system 500, multiple (three in the example of FIG. 21) nodes 501-1 to 501-3 are connected to one another through a network 503. To each of the nodes 501-1 to 501-3, a storage device 502 being a physical device is connected.

Among the nodes 501-1 to 501-3, the node 501-1 functions as a manager node that manages the remaining nodes 501-2 and 501-3. The nodes 501-2 and 501-3 function as agent nodes that execute processes under control of the manager node 501-1. Hereinafter, the manager node 501-1 is sometimes represented by Mgr #1; and the agent node 501-2 is sometimes represented by Agt #2; and the agent node 501-3 is sometimes represented by Agt #3.

A request from a user is input into the manager node 501-1, and the manager node 501-1 creates multiple processes (commands) that the agent nodes 501-2 and 501-3 are to be instructed to execute in order to achieve the request from the user.

FIG. 22 is a diagram illustrating an example of a manner of processing a request from a user in a traditional SDS system 500.

The example of FIG. 22 illustrates a process performed when a user requests to create a mirror volume.

The user inputs a request for creating a mirror volume into the manager node 501-1 (see the reference number S1). In response to the request, the manager node 501-1 creates multiple (five in the example of FIG. 22) commands (i.e., create Dev #2_1, create Dev #2_2, create Dev #31, create Dev #3_2, and create MirrorDev) (see the reference number S2).

The manager node 501-1 requests the agent nodes 501-2 and 501-3 to process the created commands (see the reference number S3).

In the example of FIG. 22, the Agt #2 is requested to process the commands “create Dev #2_1” and “create Dev #2_2” (see the reference number S4) and the Agt #3 is requested to process the commands “create Dev #31”, “create Dev #3_2”, and “create MirrorDev” (see the reference number S5).

Upon receipt of the requests, the agent nodes 501-2 and 501-3 execute requested commands (processes) (see the reference numbers S6 and S7), and respond to the manager node 501-1 with completion of the commands. The manager node 501-1 confirms the respective responses transmitted from the agent nodes 501-2 and 501-3 (see the reference number S8).

[Patent Literature 1] Japanese Laid-open Patent Publication No. 09-319633

However, in such a traditional SDS system, multiple commands that the manager node 501-1 generates in response to a request from the user have ordinality. Accordingly, the manager node 501-1 is required to receive all the completion responses transmitted from the agent nodes 501-2 and 501-3 and manage whether the commands are executed in proper sequence (in a proper order).

Specifically, the manager node 501-1 receives completion responses that the agent node 501-2 transmits each time the process of one of the commands “create Dev #2_1” and “create Dev #2_2” is completed. Furthermore, the manager node 501-1 receives completion responses that the agent node 501-3 transmits each time the process of one of the commands “create Dev #31”, “create Dev #3_2”, and “create MirrorDev” is completed.

Since a traditional SDS system requires the manager node 501-1 to receive and confirm completion responses that the agent nodes 501-2 and 501-3 transmit each time a process of a command is completed, the system is heavily loaded with the requirement for process of completion response.

### SUMMARY

According to an aspect of the embodiments, an information processing apparatus connected to a plurality of control nodes through a network, the information processing apparatus including: a memory; and a controller that is coupled to the memory and that controls the plurality of control nodes, the controller being configured to: transmit a task executing request to a first control node that is to execute a task including a plurality of processes and that is one of the plurality of control nodes; and store management information that associates the task executing request transmitted to the first control node with a response result received from the first control node, the task executing request including: a command to execute the task; a command to respond with a first notification indicating that the plurality of processes included in the task is normally completed; a command to execute, when execution of at least one of the plurality of processes fails, a regaining process that regains statuses of one or more remaining processes successfully executed to statuses before being executed; and a command to response, when execution of the regaining process is normally completed, a second notification indicating that the regaining process is normally completed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating the hardware configuration of a storage system according to one example of an embodiment;

FIG. 2 is a diagram illustrating an example of logical devices formed in the storage system of an example of an embodiment;

FIG. 3 is a diagram illustrating the functional configuration of a storage system of an example of an embodiment;

FIG. 4 is a diagram illustrating an example of job management information in a storage system of an example of an embodiment;

FIGS. 5A and 5B are diagrams illustrating examples of a task of a storage system of an example of an embodiment;

FIG. 6 is a diagram illustrating an example of task management information in a storage system of an example of an embodiment;

FIG. 7 is a diagram illustrating transition of task progress information in the storage system of an example of an embodiment;

FIG. 8 is a diagram illustrating an overview of procedural steps of processing a request from a user in a storage system of an example of an embodiment;

FIG. 9 is a diagram illustrating an overview of procedural steps of processing a request from a user in a storage system of an example of an embodiment;

FIG. 10 is a diagram illustrating an overview of procedural steps of processing a request from a user in a storage system of an example of an embodiment;

FIG. 11 is a diagram illustrating an overview of procedural steps of processing a request from a user in a storage system of an example of an embodiment;

FIG. 12 is a diagram illustrating an overview of procedural steps of processing a request from a user in a storage system of an example of an embodiment;

FIG. 13 is a diagram illustrating an overview of procedural steps of processing a request from a user in a storage system of an example of an embodiment;

FIG. 14 is a flow diagram illustrating a succession of procedural steps performed by a manager node in a storage system of an example of an embodiment;

FIG. 15 is a flow diagram illustrating a succession of procedural steps performed by an agent node in a storage system of an example of an embodiment;

FIG. 16 is a flow diagram illustrating a succession of procedural steps performed when a storage system of an example of an embodiment is normally operating;

FIG. 17 is a flow diagram illustrating a succession of procedural steps of a roll-back process that a failure in processing a task accompanies in a storage system of an example of an embodiment;

FIG. 18 is diagram illustrating transition of task management information in a storage system of an example of an embodiment;

FIG. 19 is a flow diagram illustrating a succession of procedural steps performed when execution of an irreversible command fails in a storage system of an example of an embodiment;

FIG. 20 is a flow diagram illustrating a succession of procedural steps of a process performed when a manger node goes down while an agent node is executing a process in a storage system of an example of an embodiment;

FIG. 21 is a diagram schematically illustrating a configuration of a traditional SDS system; and

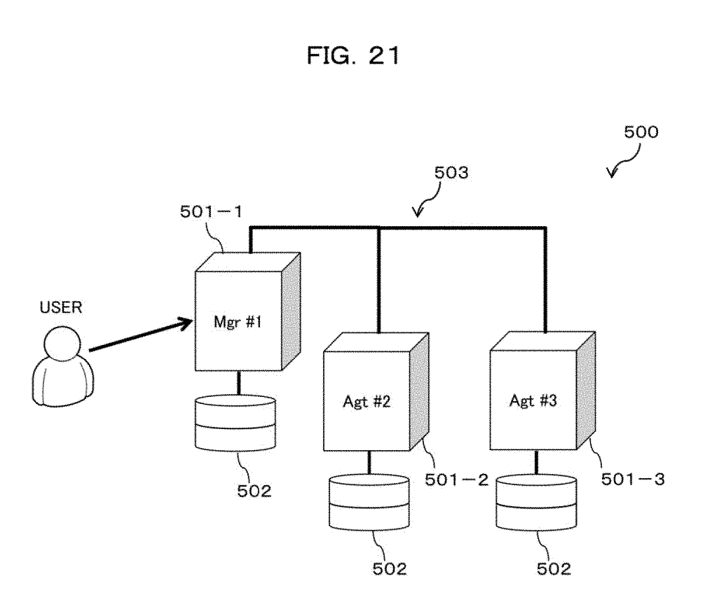

FIG. 22 is a diagram exemplarily illustrating a method for processing a request from a user in a traditional SDS system.

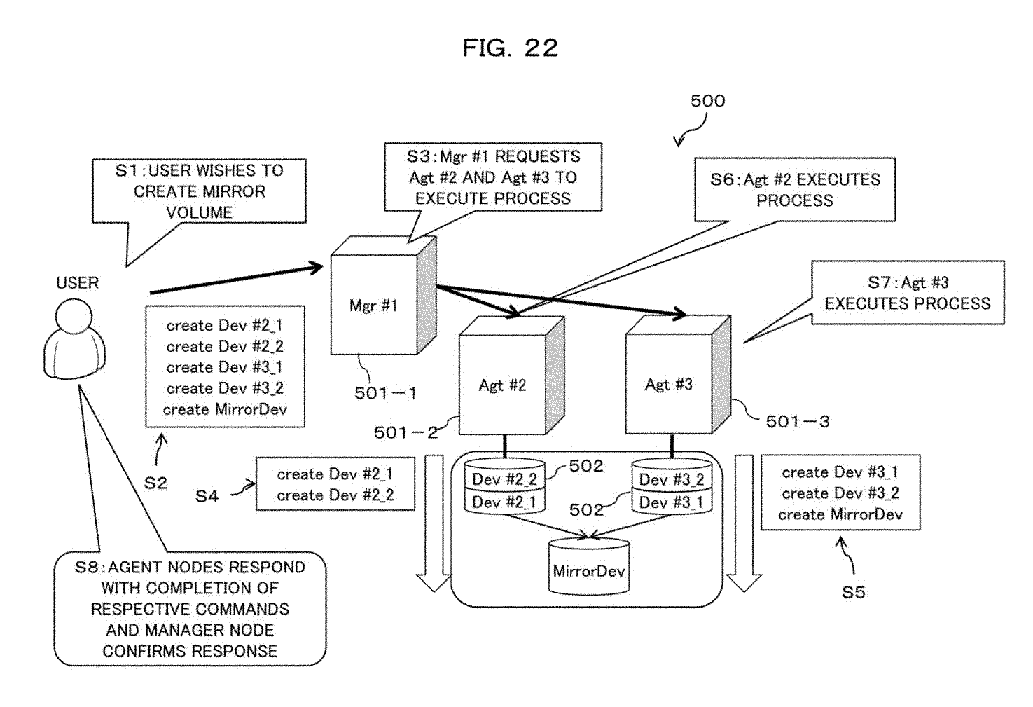

### DESCRIPTION OF EMBODIMENT(S)

Hereinafter, description will now be made in relation to an information processing apparatus, an information processing system, and a non-transitory computer-readable recording medium having stored therein a control program according an embodiment of the present invention with reference to the accompanying diagram. The embodiment to be detailed below is merely exemplary and does not have intention to exclude various modifications and applications of techniques not referred in the following embodiment. The following embodiment may be variously modified without departing from the scope thereof. Throughout the drawings used in the following embodiment, like reference numbers designate the same or substantially same parts and elements unless otherwise described. Further, the drawings do not intend that the embodiments include only the elements illustrated in the drawings and can include other functions and the like.

(A) Configuration:

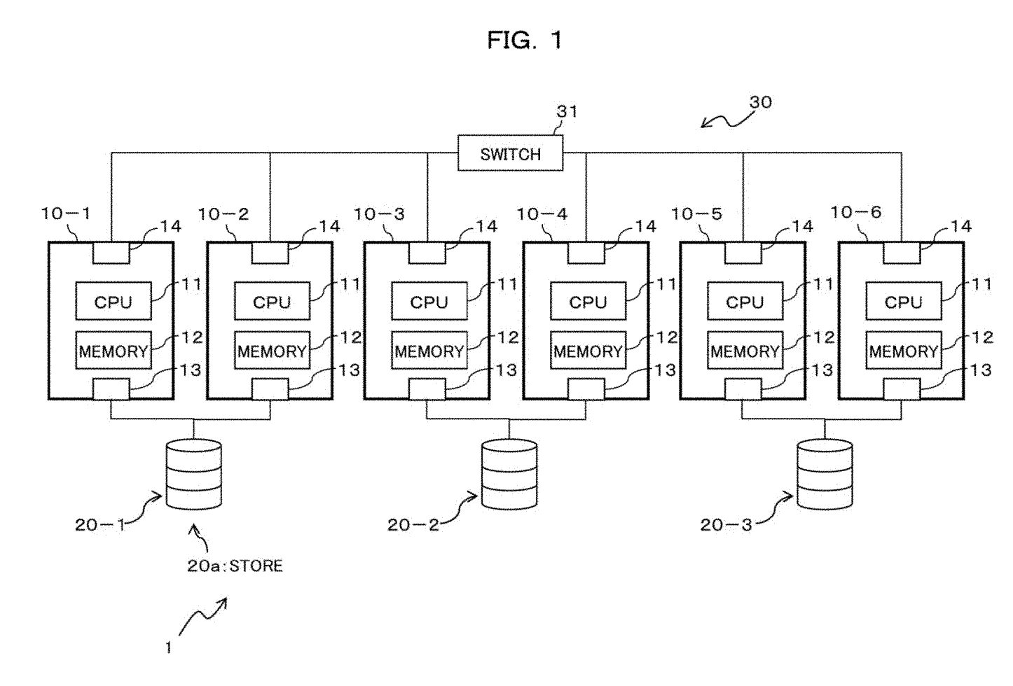

FIG. 1 is a diagram schematically illustrating the hardware configuration of the storage system 1 according an example of to an embodiment.

A storage system 1 is an SDS system provided with multiple (six in the example of FIG. 1) storage control nodes (control nodes 10, hereinafter sometimes simply referred to as “nodes”) 10-1 to 10-6 each control storage.

The nodes 10-1 to 10-6 are communicably connected to one another via a network 30.

An example of the network 30 is a Local Area Network (LAN) and includes, in the example of FIG. 1, a network switch 31. The nodes 10-1 to 10-6 are communicably connected to one another by being connected to the network switch 31 via respective communication cables.

Hereinafter, when particular one of the multiple nodes needs to be specified, a reference number one of 10-1 to 10-6 is used, but an arbitrary node is represented by a reference number 10.

In the present storage system 1, one of the multiple nodes 10 functions as a manager node, and the remaining nodes 10 function as agent nodes. The manager node is a commander node that manages the remaining nodes (agent nodes) 10 in the storage system 1 having a multi-node structure formed of multiple nodes 10 and that issues commands to the remaining nodes 10. An agent node executes a process in obedience to a command issued from the commander node.

The following example assumes that the node 10-1 is the manager node and the nodes 10-2 to 10-6 are the agent nodes.

Hereinafter, the node 10-1 is sometimes referred to as the manager node 10-1 and also represented by Mgr #1; and the nodes 10-2 to 10-6 are sometimes referred to the agent nodes 10-2 to 10-6 and also represented by Agt #2 to #6, respectively.

In the event of a failure of the manager node 10-1, any one of the agent nodes 10 takes over the operation of the manager node 10-1 and functions as a new manager node.

A physical device “a Just a Bunch Of Disks” (JBOD) 20-1 is connected to the node 10-1 and the node 10-2, and the nodes 10-1 and 10-2 and the JBOD 20-1 are managed as a single node block (i.e., storage case). Likewise, a JBOD 20-2 is connected to the nodes 10-3 and 10-4; and a JBOD 20-3 is connected to the nodes 10-5 and 10-6.

Hereinafter, when particular one of the JBOD needs to be specified, a reference number one of 20-1 to 20-3 is used, but an arbitrary JBOD is represented by a reference number 20.

A JBOD 20 is a group of storage devices formed by logically coupling multiple physical storage devices and is configured such that the capacities of the respective storage devices can be used as logical mass storage (logical device) as a whole.

Examples of storage devices constituting a JBOD 20 are a Hard disk drive (HDD), a Solid State Drive (SSD), and a Storage Class Memory (SCM). A JBOD is achieved by any known method and the detailed description thereof is omitted here.

The present storage system 1 is configured to allow a node 10 to access a JBOD 20 connected to another node 10 by accessing the other node through the switch (network switch) 31.

The path to each JBOD 20 is made to be redundant because two nodes 10 are connected to the JBOD 20.

In each node 10, a logical device may be formed by using the storage region of the JBOD 20.

Each node 10 is accessible to a logical device of another node 10 through the network 30. In addition, each node 10 is accessible to management information of a logical device of another node 10 through the network 30. Furthermore, each node 10 is accessible to non-volatile information (store 20a to be detailed below) of another node 10 through the network 30.

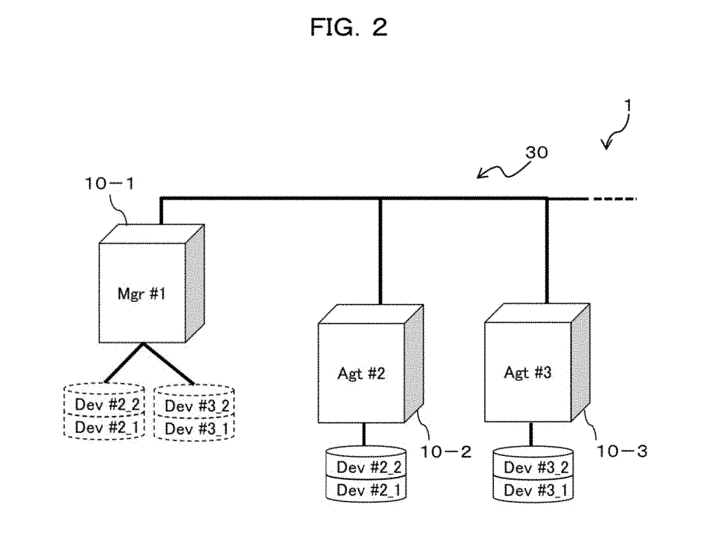

FIG. 2 is a diagram illustrating an example of a logical device formed in the storage system 1 of an example of the embodiment.

In the example of FIG. 2, logical devices #2_1 and #2_2 are connected to the agent node 10-2 (Agt #2), and logical devices #3_1 and #3_2 are connected to the agent node 10-3 (Agt #3).

The manger node 10-1 (Mgr #1) is accessible to the logical devices #2_1 and #2_2 of the agent node 10-2 and also to the logical devices logical devices #31 and #3_2 of the agent node 10-3 through the network 30. With this configuration, the manager node 10-1 can refer to and update the logical devices #2_1 and #2_2 of the agent node 10-2 and the logical devices logical devices #31 and #3_2 of the agent node 10-3.

Likewise, the agent node 10-2 is accessible to the manager node 10-1 (Mgr #1) and the logical devices #31 and #3_2 of the agent node 10-3 through the network 30; and the agent node 10-3 is accessible to the manager node 10-1 (Mgr #1) and the logical devices #2_1 and #2_2 of the agent node 10-2 through the network 30.

The stack configuration of the logical devices of each node 10 is constructed and operated by multiple different commands.

Among the multiple JBODs 20 provided to the present storage system 1, a part of the storage region of the JBOD 20 connected to the manager node 10-1 is used as a store 20a.

The store 20a is a non-volatile storage region (non-volatile storage device, memory) and stores job management information 201 and task management information 202 that are to be detailed below to make the stored information persistent. The store 20a is an external device accessible from the multiple other agent nodes 10. The information stored in the store 20a is persistent information, which achieves the information stored in the store 20a to be persistent. In other words, storing information into the store 20a makes the data persistent.

An example of each node 10 is a computer having a server function and consists of elements of a CPU 11, a memory 12, a disk interface (I/F) 13, and a network interface 14. These elements 11-14 are configured to be communicably connected to one another via a non-illustrated bus.

Each node 10 provides the storage region of the subordinate JBOD 20 as a storage resource.

The network I/F 14 is a communication interface that communicably connects the local node 10 to other nodes 10 through the switch 31. Examples of the network I/F 14 are a Local Area Network (LAN) interface and a Fiber Channel (FC) interface.

The memory 12 is a storing memory including a Read Only Memory (ROM) and a Random Access Memory (RAM). In the ROM of the memory 12, an Operating System (OS), a software program for the purpose of control in the storage system, and data for the program are stored. The software program in the memory 12 is appropriately read and executed by the CPU 11. The RAM of the memory 12 is used as a primary storing memory or a working memory.

In the storage system 1, the multiple nodes 10 do not share a memory 12.

In particular, in a predetermined region of the RAM in the memory 12 of the manager node 10-1, the job management information 201 and the task management information 202 to be detailed below are stored.

For example, in the JBOD 20 connected to each node 10, a controlling program for a manager node (controlling program) is stored, which makes the node 10 function as a manager node 10. The controlling program for a manager node is read from, for example, the JBOD 20 and stored (expanded) in the RAM of the memory 12.

Each node 10 may include an input device (not illustrated) such as a keyboard and a mouse and an output device (not illustrated) such as a display and a printer.

Alternatively, each node 10 may be provided with a storing device that stores a controlling program for a manager node and a controlling node for an agent node.

The CPU 11 is a processing device (processor) that includes a controlling unit (controlling circuit), a calculating unit (calculating circuit), and a cache memory (register group), and carries out various controls and calculations. The CPU 11 achieves various functions by executing the OS and the programs stored in the memory 12.

In a node 10, the CPU 11 executing the controlling program for a manager node causes the node 10 to function as a manager node 10.

The manager node 10 transmits an executing module of the controlling program for an agent node to the remaining nodes 10 (agent nodes 10) included in the present storage system 1 through the network 30. In other words, the manager node 10 transmits a controlling program for an agent node to each agent node 10.

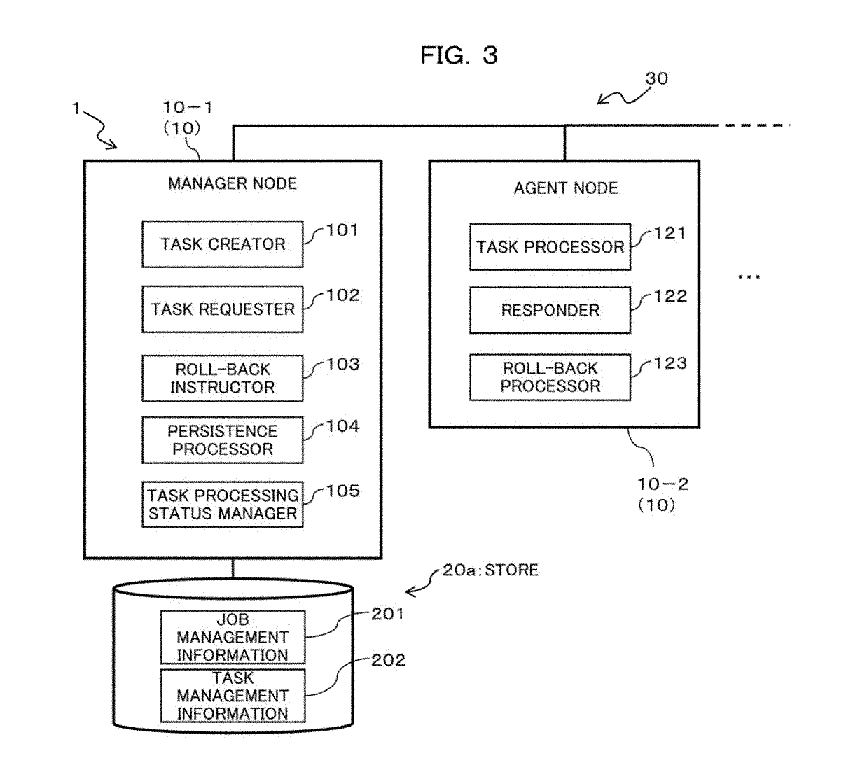

The controlling program for an agent node is a program that causes the CPU 11 of an agent node 10 to achieve the functions as a task processor 121, a responder 122, and a roll-back processor 123 (see FIG. 3).

Specifically, when the task requester 102 of the manager node 10 that is to be detailed below transmits a task executing request to another node 10, the executing module of the controlling program for an agent node is attached to the task executing request. This eliminates the requirement of each agent node 10 to install the controlling program for an agent node, so that the costs for management and operation can be reduced.

An agent node 10 functions as an agent node by the CPU 11 executing the controlling program for an agent node.

The above controlling program for a manager node is provided in the form of being recorded in a non-transitory computer-readable medium such as a flexible disk, a CD (e.g., CD-ROM, CD-R, CD-RW), a DVD (e.g., DVD-ROM, DVD-RAM, DVD-R, DVD+R, DVD-RW, DVD+RW, and HD DVD), a Blu-ray disk, a magnetic disk, an optical disk, a magneto-optical disk. A computer reads the program from the recording medium and forwards and stores the read program to and in an internal or external storage device for future use. Alternatively, the program may be recorded in a recording device (recording medium) such as a magnetic disk, an optical disk, or a magneto-optical disk, and may be provided from the recording device to the computer via a communication path.

FIG. 3 is a diagram illustrating the functional configuration of the storage system 1 of an example of the embodiment.

[Manager Node]

As illustrated in FIG. 3, the manager node 10-1 achieves the functions of the task creator 101, the task requester 102, the roll-back instructor 103, a persistence processor 104, and a task processing status manager 105 by the local CPU 11 executing the controlling program for a manager node.

In the present storage system 1, the user inputs a request directed to a logical device into the manager node 10-1.

The task creator 101 generates a job including multiple tasks on the basis of the request directed to the logical device input by the user.

In the present storage system 1, a job is created for each request input by the user. This means that the manager node 10-1 receives a process in a unit of a job.

In the storage system 1, multiple tasks are executed to accomplish a single job.

A task contains a series of processes (commands) that a node 10 is instructed to execute. A command is a minimum unit of an operation on a logical device. A task is created for each node 10 and the commands contained in a single task are processed by the same node 10. This means that a task includes one or more commands for a single job and that are dedicated to each node 10 that is to execute the commands.

The present storage system 1 shall ensure atomicity in a unit of a task. This means that the sequence of executing commands in each individual task is determined and a command is not executed unless the process of the previous command is completed.

The task creator 101 generates job management information 201 related to a job.

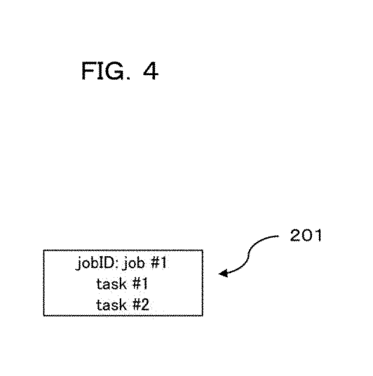

FIG. 4 is a diagram illustrating an example of the job management information 201 of the storage system 1 of an example of the embodiment.

The job management information 201 illustrated in FIG. 4 includes a job identifier (Job ID) to specify the job and a task identifier to specify each of the tasks constituting the job.

The job management information 201 illustrated in FIG. 4 relates to a job having a Job ID of “job #1”, which includes two tasks of task #1 and task #2.

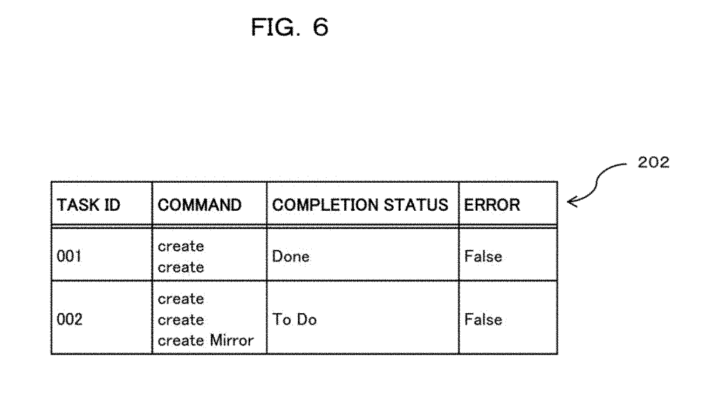

Furthermore, the task creator 101 creates task management information 202 (to be detailed below with reference to FIG. 6) for each task that the task creator 101 creates.

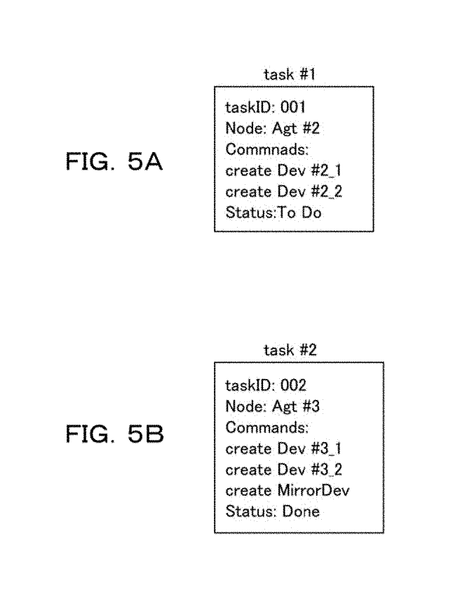

FIGS. 5A and 5B are diagrams illustrating an example of a task in the storage system 1 of an example of the embodiment. FIG. 5A exemplarily illustrates the task #1 and FIG. 5B exemplarily illustrates task #2.

As illustrated in FIGS. 5A and 5B, each task includes multiple commands.

For example, the task #1 illustrated in FIG. 5A includes commands “create Dev #2_1” and “create Dev #2_2”. Namely, the task #1 constructs devices Dev #2_1 and Dev #2_2.

The task #2 illustrated in FIG. 5B includes three commands of “create Dev #31”, “create Dev #3_2”, and “create MirrorDev”. Namely, the task #2 constructs devices Dev #31 and Dev #3_2, and also constructs MirrorDev.

The commands of the task #1 are executed in sequence of “create Dev #2_1” and “create Dev #2_2”, and the commands of the task #2 are executed in sequence of “create Dev #31”, “create Dev #3_2”, and “create MirrorDev”. A job ensures atomicity in a unit of a task.

FIGS. 5A and 5B each denote a task identifier (task ID) that univocally specifies the task, node identifying information (Node) that identifies a node that is to execute the commands included in the task, and task progress information (Status) indicative of a progress status of the task.

These pieces of information is recorded in and managed by the task management information 202.

FIG. 6 is a diagram exemplarily illustrating the task management information 202 of the storage system 1 of an example of the embodiment.

The task management information 202 exemplarily illustrated in FIG. 6 corresponds to the task #1 and the task #2 illustrated in FIGS. 5A and 5B.

The task management information 202 is information related to tasks. The task management information 202 exemplarily illustrated in FIG. 6 associates a TASK ID with COMMAND, COMPLETION STATUS, and ERROR.

A TASK ID is a task identifier that univocally specifies a task. In the example of FIG. 6, the task ID “001” represents the task #1 illustrated in FIG. 5A, and the task ID “002” represents the task #2 illustrated in FIG. 5B.

In the field of COMMAND, the commands included in the task are listed. In the task management information 202 of FIG. 6, only the body of each command is indicated, and the arguments and the options thereof are omitted.

In cases where the roll-back processor 123 that is to be detailed below issues a command to execute a roll-back process on an agent node that has failed in executing the task, a command “Rollback” indicating that a roll-back process has been instructed is set in the field of COMMAND associated with the failed task (see Table D).

The COMPLETION STATUS is task progress information (Status) indicative of the progress status of the task. The task progress information is set to either one of “To Do” indicating that the process of the task is in the status of not being executed yet and “Done” indicating that the process of the task is in the status of being completed.

For example, in cases where the manager node 10-1 receives completion notification of a task or completion notification of a roll-back process (to be detailed below) from an agent node 10, a task processing status manager 105 to be detailed below updates the task progress information of the task management information 202 from “To Do” to “Done”.

In contrast, in cases where the roll-back instructor 103 that is to be detailed below transmits a roll-back command to an agent node 10, the task processing status manager 105 updates the task progress information of the task management information 202 from “Done” to “To Do”.

Hereinafter, the completion status (task progress information) of the task management information 202 is sometimes referred to as a “status”.

In the task management information 202 of FIG. 6, the task #1 having a task ID “001” includes two commands of “create”, and the completion status (task progress information) is “Done”, which represents that the task #1 is in the status of being already completed.

In contrast, in the task management information 202 of FIG. 6, the task #2 having a task ID “002” executes a command “create MirrorDev” after executing two commands “create”. The task progress information of this task is “To Do”, which means that the task #2 is in the status of not being carried out yet (not executed yet) by the agent node 10-3.

The “ERROR” is information indicating as to whether a failure occurs while a command included in the task is being executed. For example, in cases where a failure occurs in the execution of any of the commands included in the task, the task processing status manager 105 that is to be detailed below sets “True”, which means occurrence of a failure, in the field of ERROR. In contrast, in cases where no failure occurs in the execution of any of the commands included in the task, the indication of “False”, which means occurrence of no failure, is set in the field of ERROR.

The task creator 101 may specify one or more agent nodes 10 that are to be instructed to execute tasks among the multiple agent nodes 10 included in the present storage system 1 and create the tasks one for each of the specified agent nodes 10. The agent nodes 10 that are to be instructed to execute tasks may be specified in various manner, such as preferentially selecting agent nodes 10 having low loads among the multiple agent nodes 10.

The task management information 202 created by the task creator 101 is stored in a predetermined region of the memory 12. The task management information 202 stored in the memory 12 is made persistent when being stored in the store 20a by the persistence processor 104 that is to be detailed below.

The task management information 202 may include node specifying information (Node) to specify a node 10 that is to execute the commands included in the task.

The task requester 102 transmits the task created by the task creator 101 to the agent node 10 that is to execute the task and thereby requests the agent node 10 to execute the task.

For example, the task requester 102 extracts a task having the task progress status set to “To Do” with reference to the task management information 202, and transmits a task executing request to an agent node 10 specified by the node specifying information of the task management information 202 of the extracted task to request the specified agent node 10 to execute the task.

To a task executing request that the task requester 102 transmits to an agent node 10, an executing module of a program (control program for an agent node) to cause the CPU 11 of the agent node 11 to achieve the functions of the task processor 121, the responder 122, and the roll-back processor 123 is attached. This means that the task requester 102 transmits the controlling program for an agent node to each agent node 10.

In cases of receiving a notification (failure notification) indicative of a failure in the execution of a task from an agent node 10, the roll-back instructor 103 causes one or more agent nodes 10 that execute the remaining tasks included in the same job as the failed task to execute a regaining process (roll-back process) that regains the statuses to statuses before the execution of the respective tasks.

For example, in cases where a failure in the task #2 is notified from the Agt #3 in relation to the task #1 and task #2 illustrated in FIGS. 5A and 5B, the roll-back instructor 103 instructs the Agt #2 that executes the task #1 included in the same job #1 as the task #2 to execute a roll-back process that regains a status to one before the execution of the task #1.

The roll-back instructor 103 transmits a notification (a roll-back command) to instruct execution of a roll-back process to an agent node 10.

Here, a roll-back process is to regain the status of the agent node 10 that has executed a task to a status before the execution of the task.

Accordingly, it is preferable that each of the commands included in a task is reversible to achieve such a roll-back process.

Here, if a command is one (generative command) that generates some article exemplified by a command to generate a volume, the status can be regained a status before the execution of the command by deleting the product (e.g., a volume) generated through the execution of the command. A command that can regain the status to a status before the execution of the command simply by deleting the product obtained through the execution of the command is referred to as a reversible command.

Besides, in relation to a command (information updating command) that updates information such as a name or an attribute, the status can be regained to one before the execution of the command by resetting (rewriting) the information to information before the updating. Accordingly, an information updating command also corresponds to a reversible command.

For a reversible command, a process that disregards (e.g., deletes or rewrites) the product (result) obtained by executing the command can regain the status to the status before the execution of the command.

In the present storage system 1, the roll-back processor 123 achieves rolling back that regains the status after the execution of such a reversible command to a status before the execution of the command by deleting the product or resetting the information.

In contrast to such a reversible command, execution of a command (deleting command) that, for example, deletes a volume does not generate anything through the execution of the command and does not ensure that, in cases where data in the memory 12 is lost, the status is regained to a status before the execution of the command, so that it has a difficulty in regaining the status before the execution of the command. A command, such as the above deleting command, that has a difficulty in regaining the status to one before the execution of the command is referred to as an irreversible command.

An irreversible command is unable to regain the status to a status before the executing the command simply by executing, after the completion of the command, a process (e.g., deleting or rewriting) of disregarding the result (product) obtained by execution of the command.

The roll-back instructor 103 instructs an agent node 10 that has executed a task consisting of reversible commands to execute a roll-back process.

The persistence processor 104 carries out a process that stores information related to a task into the store 20a. For example, when the manager node 10-1 receives a job from a user, the persistence processor 104 reads the job management information 201 and the task management information 202 related to the received job from the memory 12 and stores the read information 201 and 202 into the store 20a.

The persistence processor 104 stores a status (e.g., success or fail) of transaction of a process related to the task with an agent node 10 into the store 20a. This makes a new manager node 10, when the manager node 10 crashes, to take over the process by referring to the store 20a.

For example, the persistence processor 104 stores a response (success/fail) notifying the result of executing a task and being transmitted from an agent node 10 into the store 20a in association with the task identifier of the task.

Furthermore, the persistence processor 104 stores information related to a roll-back command transmitted to an agent node 10 in the store 20a in association with the task identifier of a task of which process is to be cancelled by the roll-back command.

Furthermore, the persistence processor 104 stores information indicating the contents of a response (e.g., whether the execution of a task succeeded or failed) to the roll-back command, the information being transmitted from the agent node 10, in the store 20a in association with the task identifier of the task.

When execution of all the tasks constituting a job finishes in agent nodes 10, it is preferable that the persistence processor 104 deletes the job management information 201 and the task management information 202 related to the job from the store 20a.

The task processing status manager 105 manages a processing status of a task in each agent node 10. The task processing status manager 105 updates the task progress information in the task management information 202 on the basis of a process completion notification related to the task, the notification being transmitted from the agent node 10.

The information pieces consisting of the task management information 202 are expanded (stored) in the memory 12 of the manager node 10-1, and the task processing status manager 105 updates or processes the task management information 202 on the memory 12.

The information pieces consisting of the task management information 202 on the memory 12 are stored in the store 20a by the persistence processor 104 and is thereby made persistent.

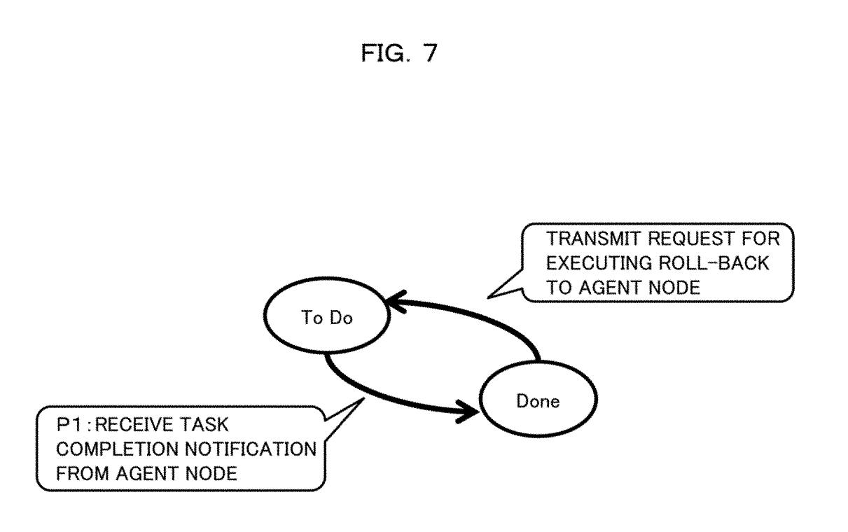

FIG. 7 is a diagram illustrating transition of task progress information in the storage system 1 of an example of the embodiment.

For example, if receiving a completion notification of a task or a completion notification of a roll-back process (to be detailed below) from an agent node 10, the task processing status manager 105 rewrites the task progress information in the task management information 202 from “To Do” to “Done” (see the reference number P1 in FIG. 7).

For example, in cases where the roll-back instructor 103 transmits a roll-back command to an agent node 10, the task processing status manager 105 rewrites the task progress information in the task management information 202 from “Done” to “To Do” (see the reference number P2 in FIG. 7).

[Agent Node]

As illustrated in FIG. 3, each of the agent nodes 10-2 to 10-6 achieves the functions of the task processor 121, the responder 122, and the roll-back processor 123 by the local CPU 11 executing the controlling program (executing module) for an agent node.

The task processor 121 executes a task that the task requester 102 of the manager node 10-1 requests to execute. Namely, the task processor 121 executes multiple commands included in the task requested to execute in processing sequence.

The roll-back processor 123 carries out a roll-back process that regains the status of the node (hereinafter sometimes referred to as “local node 10”) in which the roll-back processor 123 itself functions to a status before the task processor 121 executes the task.

For example, in cases where the task processor 121 fails in execution of any one of the commands included in the task while the task processor 121 is executing the task, the roll-back process is to be executed.

For example, in cases where execution of any one of the multiple commands included in the task fails, the roll-back processor 123 cancels the processes of all the commands executed before the execution of the failed command for the task. For example, in cases where the command executed before the execution of the failed command of the task is to generate a device, the roll-back processor 123 deletes the generated device to regain the status to one before executing the command.

The roll-back processor 123 executes a roll-back process that regains the process (result of executing) executed by a reversible command to a status before the execution of the command.

Specifically, in relation to a generative command such as a command that generates a volume, the status is regained to a status before the execution of the command by deleting the product (result, e.g., the volume) generated by executing the command. In relation to an information updating command to update information such as a name or an attribute, the status is regained to a status before the execution of the command by resetting the information to that before the updating.

In cases where a command except for a generative command and an information updating command easily regains the status to a status before the execution of the command by executing a particular command such as “undo” or “cancel”, the roll-back process may be executed on the result of the command. The roll-back process may be variously modified.

For example, the task (task #2) exemplarily illustrated in FIG. 5B is to be executed by the agent node 10-3 (Agt #3) and includes three commands of “create Dev #31”, “create Dev #3_2” and “create MirrorDev” to be carried out in this sequence.

Here, consideration will now be made in relation to an example in which execution of the command “create Dev #3_2” failed in the course of the execution of task (i.e., the task #2) by the task processor 121 of the agent node 10-3 (Agt #3). In this case, the roll-back processor 123 of the agent node 10-3 (Agt #3) cancels the process of all the commands (in this case, a single command “create Dev #3_1”) executed earlier than the execution of the command “create Dev #3_2”. This allows the agent node 10-3 (Agt #3) to regain status to one before the execution of the task (task #2).

In contrast, in cases where the roll-back processor 123 receives a roll-back command on the process executed by an irreversible command from the roll-back instructor 103 of the manager node 10-1, the roll-back processor 123 neglects the received command, not executing the roll-back process.

When the task processor 121 completes the process of a task, the responder (first responder) 122 notifies the manager node 10-1 of process completion.

The responder 122 transmits a completion notification at a timing when all the commands included in the task are executed by the task processor 121 so that a process in a unit of a task is completed. In other words, the responder 122 transmits a completion notification when a process not in a unit of a command but in a unit of a task is completed.

In the execution of a task by the task processor 121, in cases where the task processor 121 fails in execution of any of the commands included in the task, the responder 122 notifies the manager node 10-1 of the failure in the execution of the task. In this incident, it is preferable that the responder 122 notifies the manager node 10-1 of a failure in the execution of the task after the roll-back processor 123 executes the roll-back process.

Accordingly, the responder 122 functions as a first responder that responds with a first notification indicative of normal completion of the execution of a series of multiple processes (commands) included in a task.

In cases where the task processor 121 fails in execution of an irreversible command, the responder 122 refrains from notifying the manager node 10-1 of the failure of the command. Consequently, the manager node 10-1 is not notified of the failure in execution of the command, and regards the result of the execution of the command as success.

Namely, in cases where execution of an irreversible command fails, the responder 122 pretends that the execution of the command succeeded. As described above, an irreversible command is, for example, deletion of a volume.

Even if execution of an irreversible command fails, the agent node 10 leaves the failed command without notifying the manager node 10-1 of the failure, and executes the ensuing process. The responder 122 responds to the manager node 10-1 with success in execution of the entire process. Even if receiving a roll-back command directed to the task containing the failed command from the manager node 10-1, the agent node 10 ignores the command and refrains from execution of the roll-back command.

Once a process is started by an agent node 10, the process can be completed with being in a success or failure state even if the process goes into an abnormal state on its way without involving the manager node 10.

This can eliminate requirement of the manager node 10 for waiting due to an error process, so that the load on the manager node 10 can be abated. In addition, eliminating the requirement for waiting due to an error process, the manager node 10 can in turn execute a different process and can consequently enhance the process efficiency.

To pretend, in cases where execution of a command fails in an agent node 10 but the responder 122 refrains from notifying the manager node 10 of the failure, as if the executing of the command succeeded is sometimes referred to as “forced commit”.

Such a failure in execution of a command in an agent node 10 is recorded separately in a system log or the like. Accordingly, no problem is caused by the responder 122 of the agent node 10 not notifying the manager node 10 of the failure.

In the present storage system 1, the following process is executed if the manager node 10 goes down while an agent node 10 is executing a process.

Specifically, in the event of crash of the manager node 10-1, any one of the agent nodes 10 comes to be a new manager node 10.

Here, the persistence processor 104 of the manager node 10 stores a status of transaction of a process related to a task with an agent node 10 into the store 20a as described above.

A new manager node 10 can take over the process of the failed manager node 10 by referring to the store 20a.

When the roll-back instructor 103 completes a roll-back process, the responder 122 responds to the manager node 10-1 with a completion notification.

Accordingly, the responder 122 also functions as a second responder that responds with a second notification when execution of a roll-back process is normally completed.

(B) Operation:

[Overview]

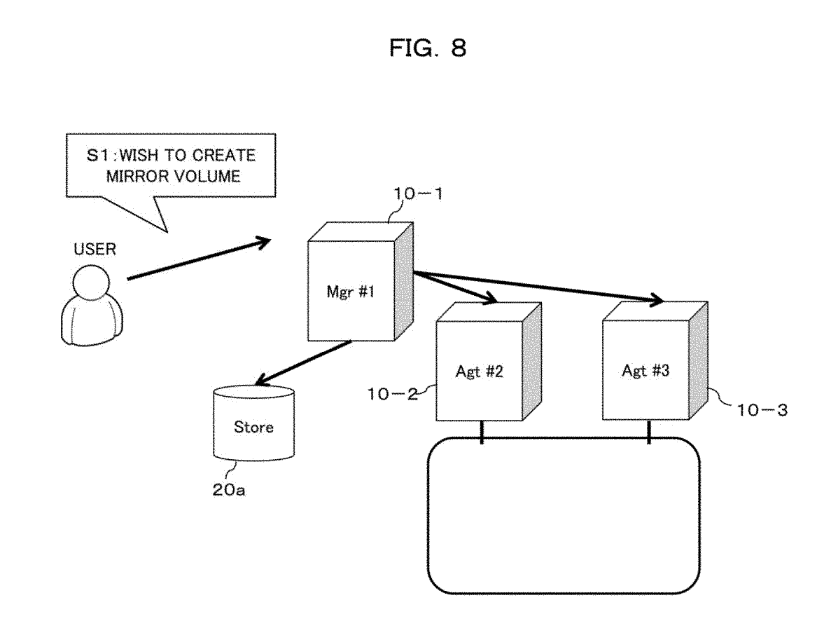

First of all, description will now be made in relation to the overview of a process of dealing with a request from the user in the storage system 1 of an example having the above configuration of the embodiment with reference to FIGS. 8-13.

The user inputs a request (job) directed to a logical device of the present storage system 1 into the manager node 10-1 (see the reference number S1 in FIG. 8).

The request from the user in this example is assumed to be a request for generating a mirror volume.

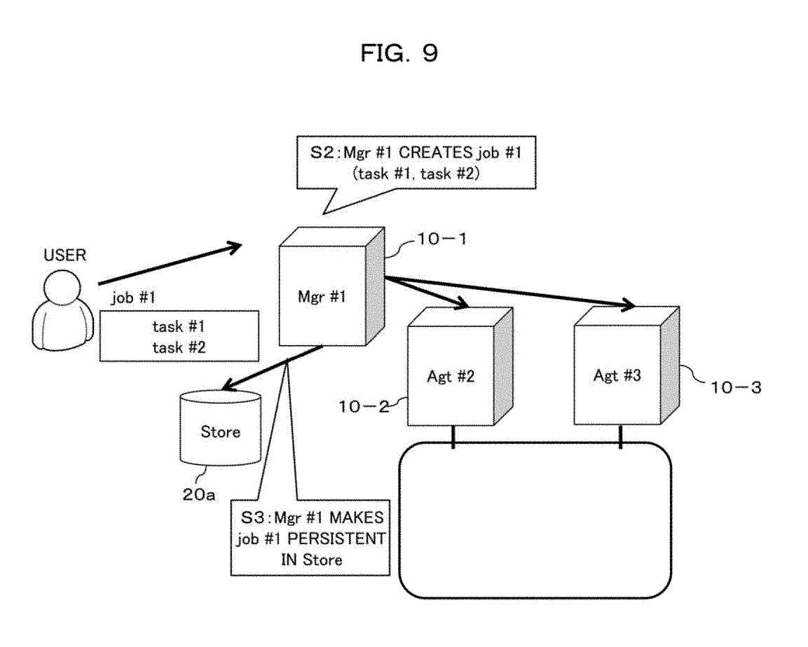

In the manager node 10-1, the task creator 101 specifies one or more target agent nodes among the multiple agent nodes and creates tasks for the specified target agent nodes 10 on the basis of the job (see the reference number S2 in FIG. 9). In the present embodiment, the task creator 101 (Mgr #1) creates a job (job #1) including a task #1 and a task #2.

In the manager node 10-1, the persistence processor 104 stores information (e.g., job management information 201) related to the created job (job #1) into the store 20a to make the information persistent (see the reference number S3 in FIG. 9).

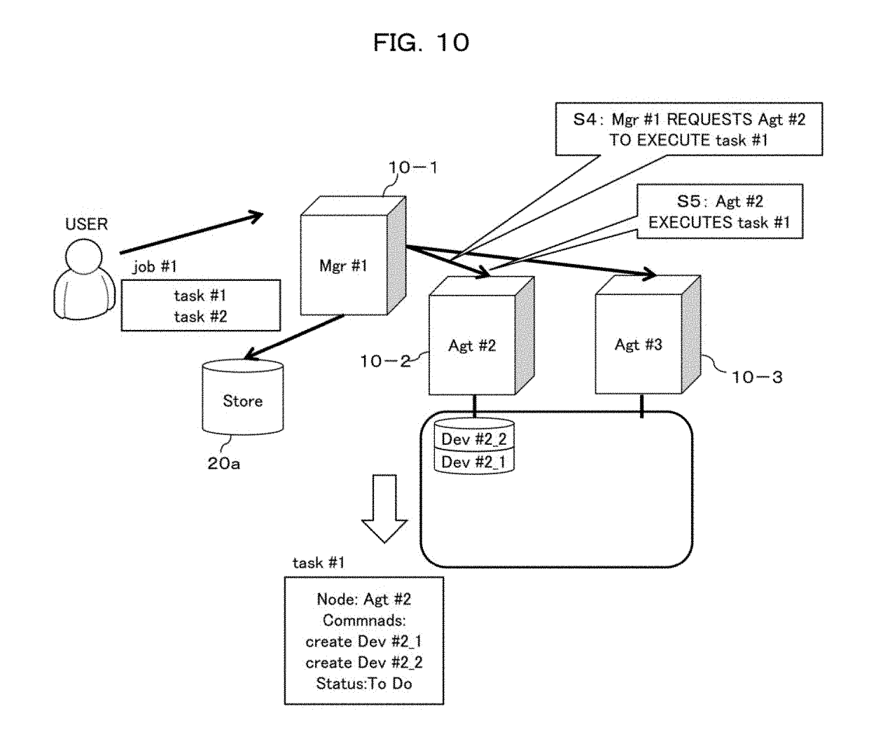

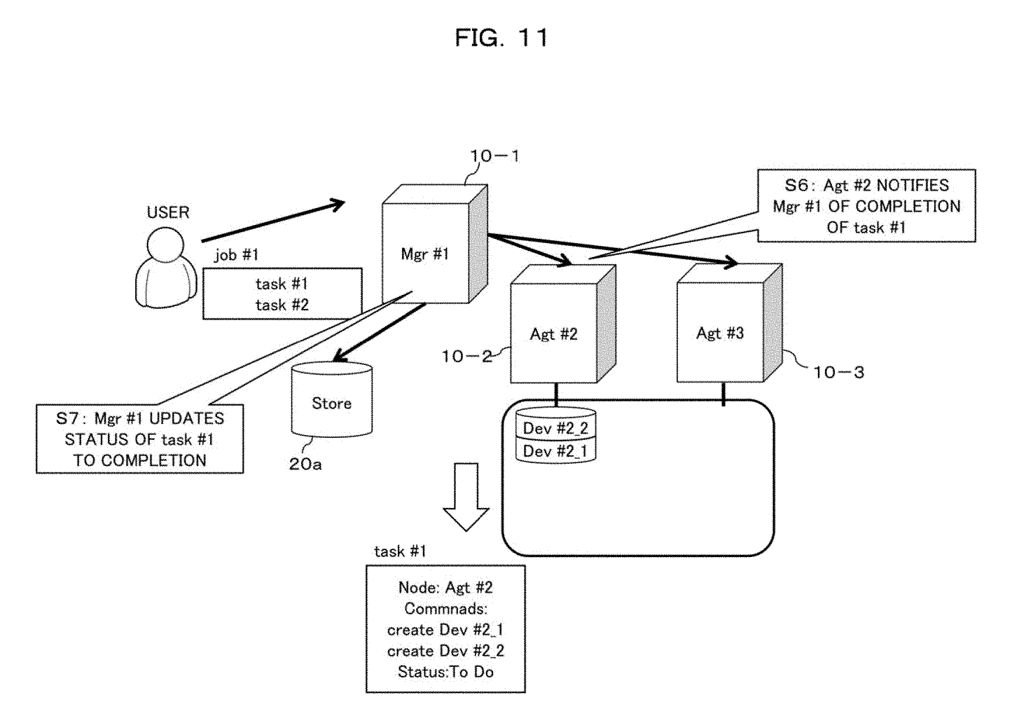

In the manager node 10-1, the task requester 102 requests the agent node 10-2 (Agt #2) to execute the task #1 (see the reference number S4 in FIG. 10), and the task processor 121 of the agent node 10-2 executes the task #2 (see the reference number S5 in FIG. 10). The responder 122 of the agent node 10-2 notifies the manager node 10-1 of completion of the task #1 (see the reference number S6 in FIG. 11).

In the manager node 10-1, the task processing status manager 105 updates the value of the task progress information of the task #1 to “Done” indicative of completion in the task management information 202 (see the reference number S7 in FIG. 11).

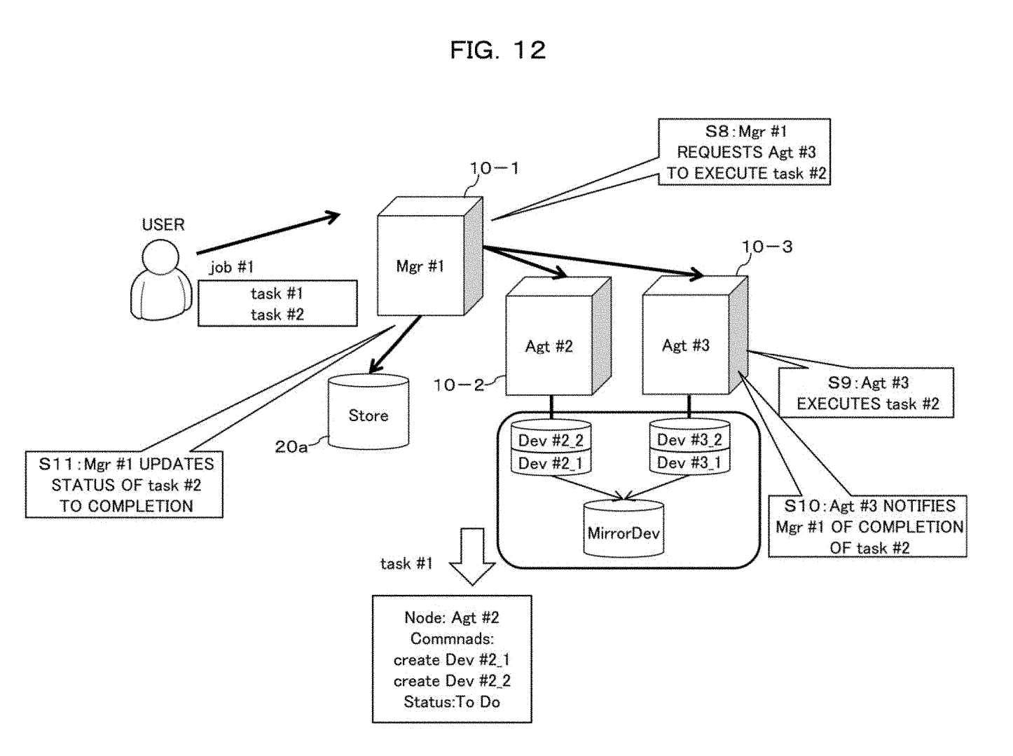

In the manager node 10-1, the task requester 102 requests the agent node 10-3 (Agt #3) to execute the task #2 (see the reference number S8 in FIG. 12), and the task processor 121 of the agent node 10-3 executes the task #2 (see the reference number S9 in FIG. 12). The responder 122 of the agent node 10-3 notifies the manager node 10-1 of completion of the task #2 (see the reference number S10 in FIG. 12).

In the manager node 10-1, the task processing status manager 105 updates the value of the task progress information of the task #2 to “Done” indicative of completion in the task management information 202 (see the reference number S11 in FIG. 12).

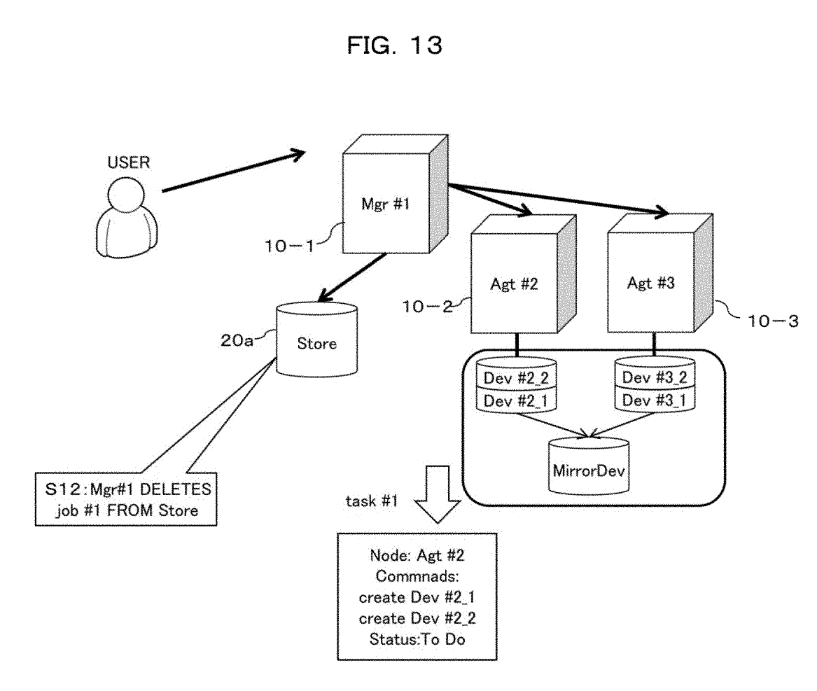

For example, the persistence processor 104 in the manager node 10-1 deletes the information (e.g., job management information 201) related to the job #1, of which process is completed, from the store 20a (see the reference number S12 in FIG. 13). This completes the process for the request input from the user.

[Manager Node]

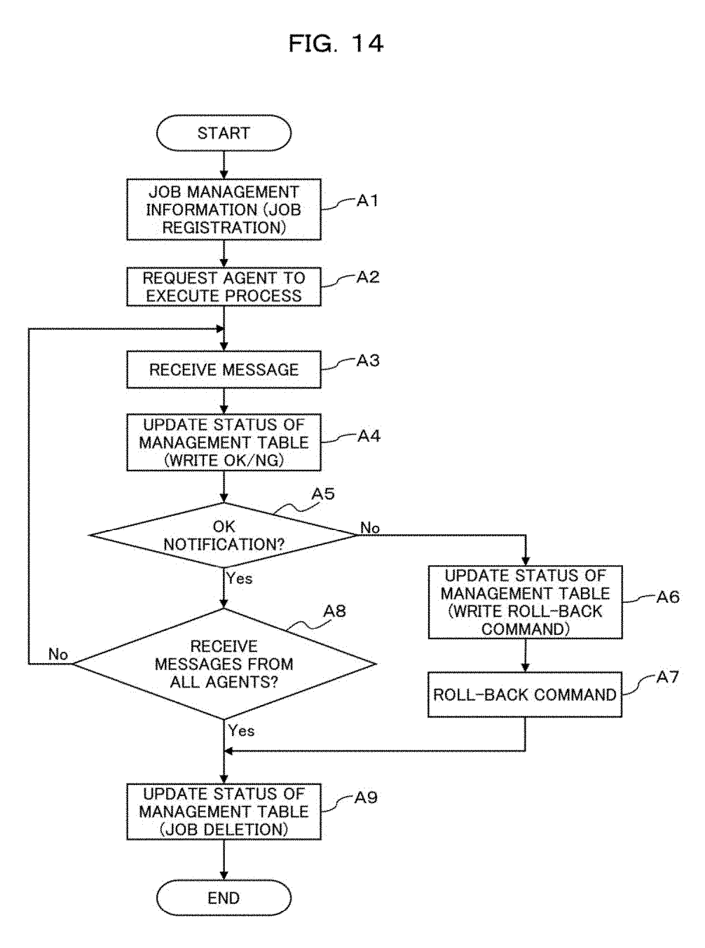

Next, description will now be made in relation to a process performed in the manager node 10-1 in the storage system 1 of an example of the embodiment with reference to a flow diagram (Steps A1 to A9) of FIG. 14.

In Step A1, the task creator 101 of the manager node 10-1 creates a job and multiple tasks constituting the job on the basis of the request that the user inputs. The task processor 121 registers the information related to the created job into the job management information 201. The task creator 101 registers information related to the created tasks into the task management information 202.

In Step A2, the task requester 102 requests the target agent nodes 10 to execute the respective generated tasks. For example, the task requester 102 requests to execute a process by sending a message requesting the process along with the task to each agent node 10.

In Step A3, the task processing status manager 105 receives a response notification message (MESSAGE) related to the task requested to execute from an agent node 10 that the task requester 102 has requested to execute the task. The response notification message from the agent node 10 includes indication (OK) of completion of processing the task or indication (NG) of failure in processing of the task.

In Step A4, the task processing status manager 105 updates the error information (i.e., the task progress information) of the task management information 202 on the basis of the received message. It is preferable that the updated task management information 202 is stored in the store 20a by the persistence processor 104 to be made persistent.

In Step A5, the task processing status manager 105 confirms whether the response notification message received from the agent node 10 is indication (OK) of completion of processing the task.

As a result of the confirmation, in cases where the received response notification message is not a notification of process completion (OK) (see No route of Step A5), the process moves to step A6.

In Step A6, the task processing status manager 105 updates the task management information 202. For example, the task processing status manager 105 registers a value indicative of a failure (FALSE) in the ERROR field (task progress information) of the task management information 202.

In the task processing status manager 105 writes information indicating that a roll-back process has been instructed into the task management information 202. It is preferable that the updated task management information 202 is stored in the store 20a by the persistence processor 104 made persistent.

In Step A7, the roll-back instructor 103 notifies the agent node 10 of a roll-back command.

The sequence of Steps A6 and A7 is not limited to one described above. Alternatively, Steps A6 and A7 may be carried out in the reverse sequence, or may be carried out in parallel with each other. After Steps A6 and A7 finish, the process moves to Step A9.

As a result of the confirmation in Step A5, in cases where the received response notification message is a notification of process completion (OK) (see Yes route of Step A5), the process moves to Step A8.

In Step A8, the task processing status manager 105 confirms whether to receive response completion messages from all the agent nodes 10 requested to execute the tasks in Step A2.

As a result of the confirmation, if an agent node 10 from which a response completion message has not been received is present (see No route of Step A8), the process returns to Step A3. In contrast, if response completion messages are received from all the agent nodes 10 (see Yes route of Step A8), the process moves to Step A9.

In Step A9, the persistence processor 104 deletes the job management information 201 and the task management information 202 related to the job #1 of which process has been completed from the store 20a. After that, the process ends.

[Agent Node]

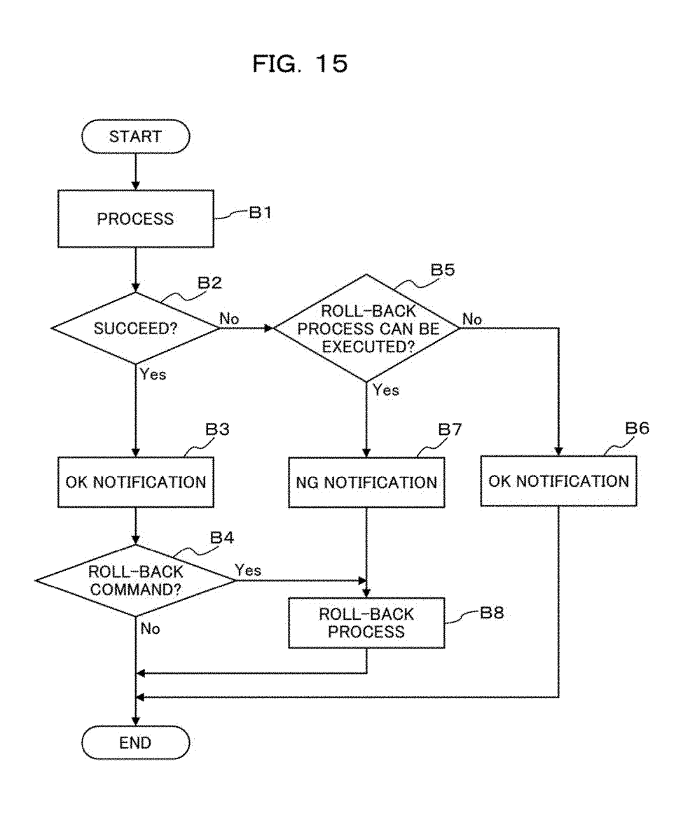

Next, description will now be made in relation to a process performed by an agent node 10 in the present storage system 1 of an example of the embodiment with reference to the flow diagram (Steps B1 to B8) of FIG. 15.

In Step B1, the task processor 121 processes a task requested from the manager node 10. This means that the task processor 121 executes multiple commands constituting the task.

In Step B2, the task processor 121 confirms whether execution of the task succeeds. If the execution of the task succeeds as a result of the confirmation (see Yes route in Step B2), the process moves to Step B3.

In Step B3, the responder 122 notifies the manager node 10 of process completion of the task (OK notification). After that, in Step B4, confirmation is made as to whether the roll-back processor 123 has received a roll-back command from the manager node 10 (the roll-back instructor 103).

If the roll-back processor 123 does not receive a roll-back command as a result of the confirmation in Step B4 (see No route in Step B4), the process ends.

In contrast, if the roll-back processor 123 receives a roll-back command as a result of the confirmation in Step B4 (see Yes route in Step B4), the process moves to Step B8.

In Step B8, the roll-back processor 123 executes a roll-back process that regains the status of the local node 10 to a status before the task is executed. After that, the process ends.

If the execution of the task fails as a result of the confirmation in Step B2 (see No route in Step B2), the process moves to Step B5.

In Step B5, confirmation is made as to whether the roll-back processor 123 can execute a roll-back process.

If a roll-back process is unable to be executed as a result of the confirmation (see No route in Step B5), the process moves to step B6. In Step B6, the responder 122 notifies the manager node 10 of process completion of the task (OK notification) and ends the process. In contrast, a roll-back process is able to be executed as a result of the confirmation (see Yes route in Step B5), the process moves to step B7.

In Step B7, the responder 122 notifies the manager node 10 of a failure in executing the task (NG notification). After that, the process moves to step B8, in which the roll-back processor 123 executes a roll-back process, and then ends.

[Normal Operation]

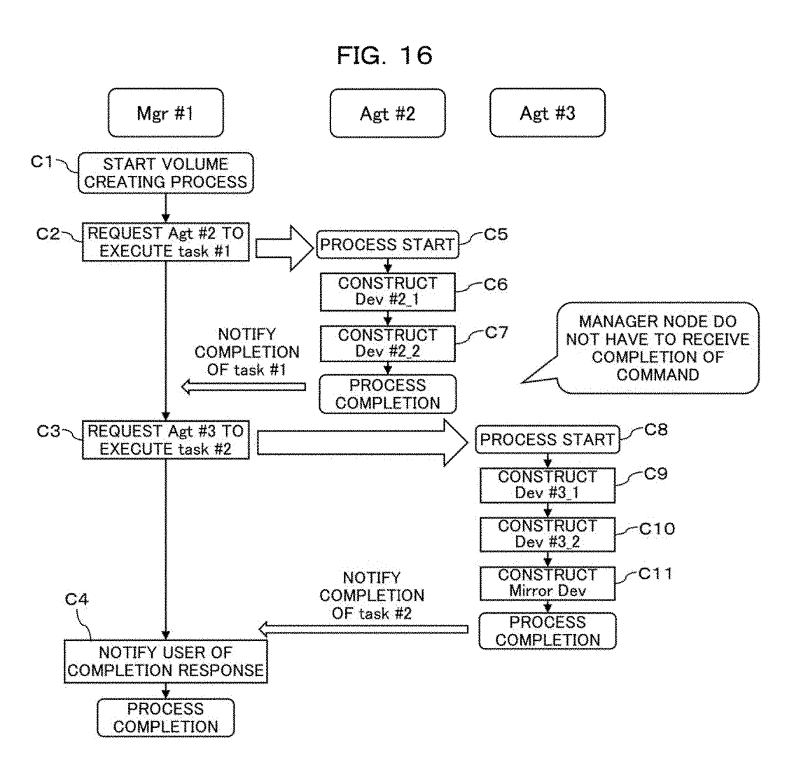

Next, description will now be made in relation to a process performed when the storage system 1 of an example of the embodiment normally operates with reference to a flow diagram (Steps C1 to C11) of FIG. 16.

The following example also assumes that a mirror volume is generated in response to the request from the user.

In Step C1, a process for creating a mirror volume is started in the manager node 10-1 (Mgr #1). To begin with, the task creator 101 of the manager node 10-1 creates a job (job #1) including task #1 and task #2.

In Step C2, the task requester 102 of the manager node 10-1 requests the agent node 10-2 (Agt #2) to execute the task #1.

In response to the request, the task processor 121 of the agent node 10-2 (Agt #2) starts processing the task #1 (Step C5). Namely, the multiple commands included in the task #1 are sequentially executed in the agent node 10-2 (Agt #2).

The task processor 121 constructs devices Dev #2_1 and Dev #2_2 (Steps C6 and C7) for the task #1, and ends the process. When the task processor 121 completes the processing of the task #1, the responder 122 transmits a completion notification of the task #1 to the manager node 10-1.

In step C3, the task requester 102 of the manager node 10-1, which has received a process completion notification of the task #1 from the responder 122 of the agent node 10-2 (Agt #2), then requests the agent node 10-3 (Agt #3) to execute the task #2.

In response to the request, the task processor 121 of the agent node 10-3 (Agt #3) starts processing the task #2 (Step C8). Namely, the multiple commands included in the task #2 are sequentially executed in the agent node 10-3 (Agt #3).

The task processor 121 constructs devices Dev #31 and Dev #3_2 (Steps C9 and C10) for the task #2, and further constructs a device MirrorDev for the task #2 in Step C11. When the task processor 121 completes the processing of the task #2, the responder 122 transmits a completion notification of the task #2 to the manager node 10-1.

In step C4, the manager node 10-1 notifies the user of the completion of creating the mirror volume, and then ends the process.

[Roll-Back Process]

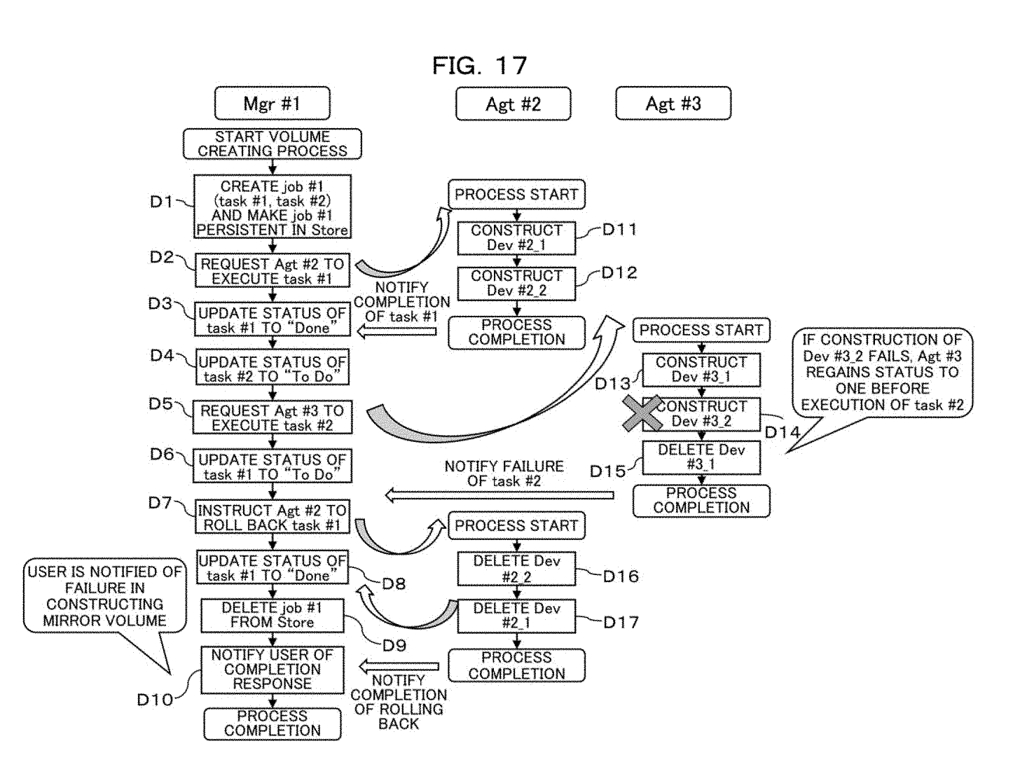

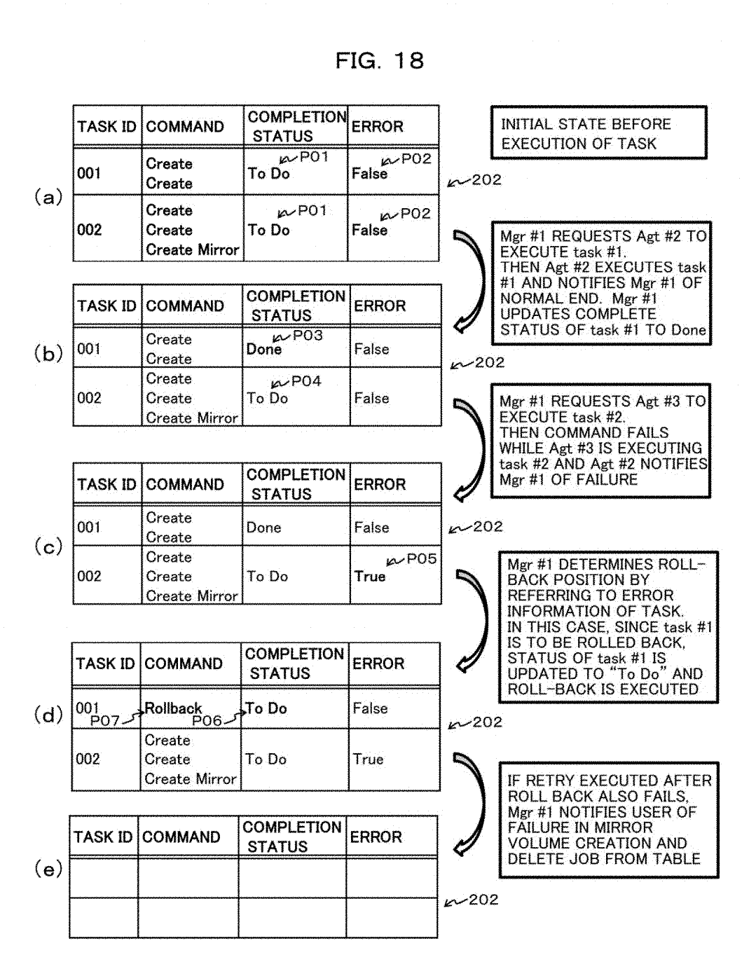

Next, description will now be made in relation to a roll-back process accompanied by a failure in processing a task in the storage system 1 of an example of the embodiment with reference to Tables A-E in FIG. 18 along the flow diagram (Steps D1 to D17) of FIG. 17. Tables A-E collectively illustrate transition of the task management information 202 in the storage system 1 of an example of the embodiment.

FIG. 17 also illustrates an example assuming that a mirror volume is generated in response to the request from the user and more specifically illustrates a case where execution of a command fails while the agent node 10-3 (Agt #3) is executing a task (task #2).

As illustrated in Table A, at the initial state of the task management information 202a, a status “To Do” is set in the completion status of each task (see the reference number P01 of Table A) and an indication “False” is set in the “ERROR” field of each task (see the reference number P02 of Table A).

In the manager node 10-1 (Mgr #1), a process of creating a mirror volume is started.

In Step D1 of FIG. 17, the task creator 101 of the manager node 10-1 creates a job (job #1) including a task #1 and a task #2. The persistence processor 104 stores information of the created job and tasks into the store 20a to make the information persistent.

In Step D2 in FIG. 17, the task requester 102 of the manager node 10-1 requests the agent node 10-2 (Agt #2) to execute the task #1.

In response to the request, the task processor 121 of the agent node 10-2 (Agt #2) starts processing the task #1. Namely, the multiple commands included in the task #1 are sequentially executed in the agent node 10-2 (Agt #2).

The task processor 121 constructs devices Dev #2_1 and Dev #2_2 (Steps D11 and D12 of FIG. 17) for the task #1, and ends the process. When the task processor 121 completes processing of the task #1, the responder 122 transmits a completion notification of the task #1 to the manager node 10-1.

In Step D3 of FIG. 17, the task processing status manager 105 of the manager node 10-1, which has received a process completion notification of the task #1 from the responder 122 of the agent node 10-2 (Agt #2), sets “Done” in the completion status (STATUS) of the task #1 (task ID: 001) of the task management information 202 (see the reference number P03 of Table B).

In Step D4 of FIG. 17, the task processing status manager 105 of the manager node 10-1 sets “To Do” in the completion status (STATUS) of the task #2 (task ID: 002) of the task management information 202 (see the reference number P04 of Table B).

In Step D5 in FIG. 17, the task requester 102 of the manager node 10-1 requests the agent node 10-3 (Agt #3) to execute the task #2.

In response to the request, the task processor 121 in the agent node 10-3 (Agt #3) starts processing the task #2. Namely, the multiple commands included in the task #2 are sequentially executed in the agent node 10-3 (Agt #3).

The task processor 121 first constructs device Dev #31 for the task #2 (Step D13 of FIG. 17). Then the task processor 121 starts constructing a device Dev #3_2, which unfortunately fails in the course of the process (Step D14 of FIG. 14).

In cases where a node 10 detects that the own task processor 121 has failed in executing a command, the roll-back processor 123 spontaneously carries out a roll-back process. For example, the roll-back processor 123 deletes the device Dev #3_1 constructed in Step D12 (Step D15 of FIG. 17).

In cases where the task processor 121 fails in processing the task #2, the responder 122 notifies the manager node 10-1 of the failure in processing the task #2. The task processing status manager 105 of the manager node 10-1 sets “True” in the ERROR field of the task #2 (task ID: 002) in the task management information 202 (see the reference number P05 in Table C).

In Step D6 of FIG. 17, the roll-back instructor 103 of the manager node 10-1 determines a roll-back position by referring to a notification (“ERROR” information of the task) from the agent node 10-3. In the present embodiment, since the task #1 is to be rolled back, the roll-back instructor 103 updates the status of the task #1 to “To Do” (see the reference number P06 of Table D) and changes the command to “Rollback” in the task management information 202 (see the reference number P07 of Table D).

In Step D7 of FIG. 17, the roll-back instructor 103 of the manager node 10-1 instructs the agent node 10-2, which has executed the task #1, to execute the roll-back process on the task #1. Responsively, the agent node 10-2 starts the roll-back process.

In Step D16 of FIG. 17, the roll-back processor 123 of the agent node 10-2 deletes the device Dev #2_2, and in the ensuing Step D17 of FIG. 17, deletes the device Dev #2_1. As the above, it is preferable that, in the event of executing a roll-back process, the roll-back processor 123 deletes the results obtained by executing multiple commands constituting the task in the reverse sequence to the sequence executing the commands.

Then the process in the agent node 10-2 ends.

Meanwhile, in the manager node 10-1, the task processing status manager 105 rewrites (updates) the status of the task #1 in the task management information 202 to “Done” in Step D8 of FIG. 17.

After that, in Step D9 of FIG. 17, the task processing status manager 105 of the manager node 10-1 deletes the tasks related to the job #1 from the task management information 202 as illustrated in Table E. Furthermore, the persistence processor 104 in the manager node 10-1 deletes the information related to the job #1 from the store 20a.

In Step D10 of FIG. 17, the manager node 10-1 notifies the user of the completion in generation of a mirror volume, and ends the process.

[Forced Commit]

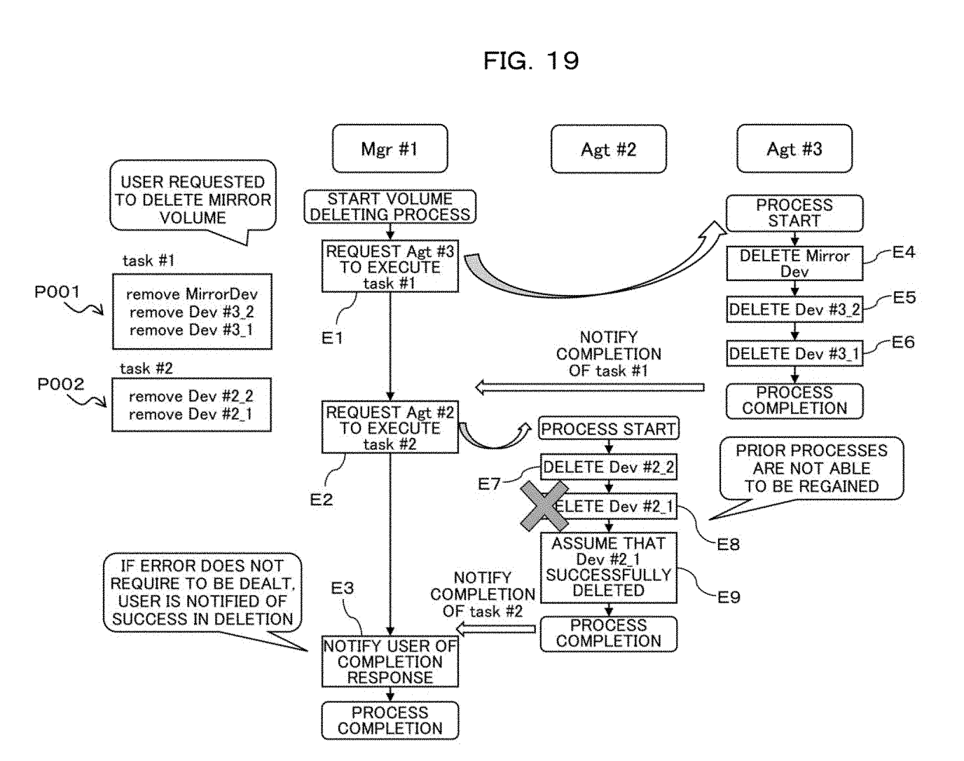

Next, description will now be made in relation to a process performed when execution of an irreversible command fails in the storage system 1 of an example of the embodiment along the flow diagram (Steps E1 to E9) of FIG. 19.

In the following example, the user requests to delete a mirror volume and the mirror volume is deleted in response to the request.

The task creator 101 creates a job containing a task #1 and a task #2 based on the volume deleting request input from the user.

Here, the task #1 includes three commands “remove MirrorDev”, “remove Dev #3_2”, and “remove Dev #3_1” (see the reference number P001 of FIG. 19).

Likewise, the task #2 includes two commands “remove Dev #2_2” and “remove Dev #2_1” (see the reference number P002 of FIG. 19).

In Step E1, the task requester 102 in the manager node 10-1 (Mgr #1) requests the agent node 10-3 (Agt #3) to execute the task #1.

In response to the request, the task processor 121 of the agent node 10-3 (Agt #3) starts processing the task #1. Namely, the multiple commands included in the task #1 are sequentially executed in the agent node 10-3 (Agt #3).

The task processor 121 deletes, in sequence, devices “MirrorDev”, “Dev #3_2”, and “Dev #31” (Steps E4 to E6), and ends the process. When the task processor 121 completes the processing of the task #1, the responder 122 transmits a completion notification related to the task #1 to the manager node 10-1.

Then the task requester 102 of the manager node 10-1 requests the agent node 10-2 (Agt #2) to execute the task #2 (Step E2).

In response to the request, the task processor 121 of the agent node 10-2 (Agt #2) starts processing the task #2. Namely, the multiple commands included in the task #2 are sequentially executed in the agent node 10-2 (Agt #2).

In the agent node 10-2, the task processor 121 first deletes the device Dev #2_1 (Step E7) for the task #1, and then assumes to fail in deleting the device Dev #2_2 (Step E8). A deleting process is an irreversible process and therefore one or more processes executed earlier than the irreversible process are unable to be regained to the statuses before being executed. This means that the roll-back processor 123 is unable to execute the roll-back process.

To deal with the above inconvenience in the present storage system 1, the responder 122 of the agent node 10-2 does not notify the manager node 10-1 of the failure in executing the command related to the device Dev #2_1, which is unable to be deleted because of occurrence of an error in Step E9. Instead, the responder 122 of the agent node 10-2 responds to the manager node 10-1 with completion of processing the task #2 (i.e., pretends as if the task #2 is completed).

In Step E3, the manager node 10-1 notifies the user of completion in deleting of the mirror volume, and ends the process.

[Fail Over]

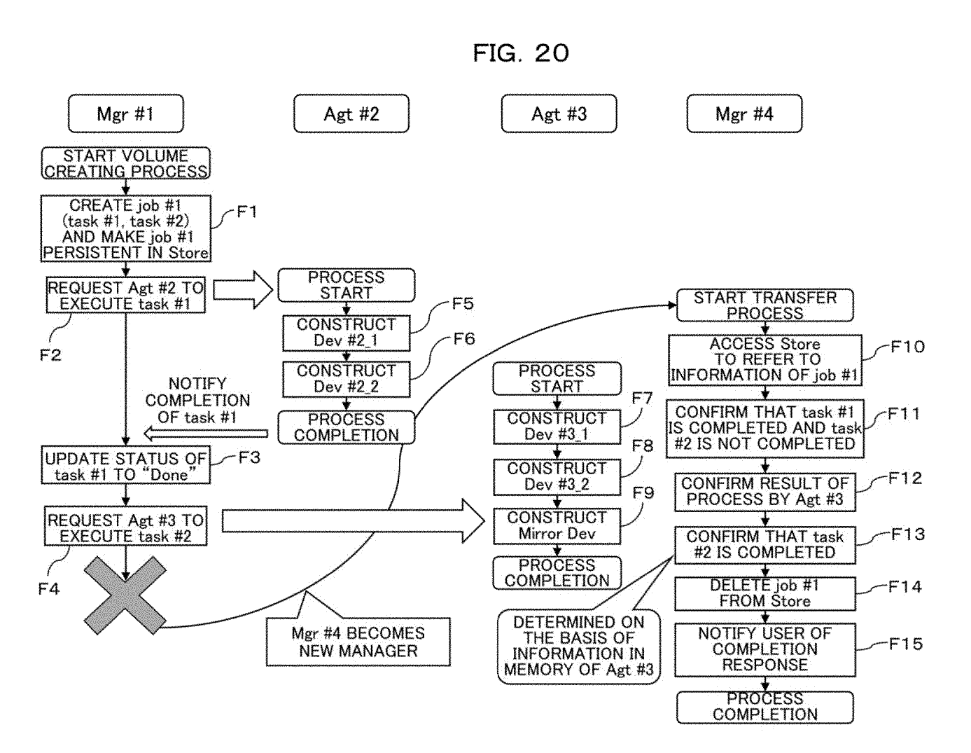

Next, description will now be made in relation to a process performed in the storage system 1 of an example of the embodiment when the manager node 10-1 goes down while an agent node 10 is executing a process along the flow diagram (Steps F1 to F15) of FIG. 20.

The following example also assumes that a mirror volume is generated in response to a request from the user.

In Step F1, the task creator 101 of the manager node 10-1 (Mgr #1) creates a job (job 1) containing a task #1 and a task #2. The persistence processor 104 stores the information of the created job and tasks into the store 20a to make the information persistent.

In Step F2, the task requester 102 of the manager node 10-1 requests the agent node 10-2 (Agt #2) to execute the task #1.

In response to the request, the task processor 121 of the agent node 10-2 (Agt #2) starts processing the task #1. Namely, the multiple commands included in the task #1 are sequentially executed in the agent node 10-2 (Agt #2).

The task processor 121 constructs the devices Dev #2_1 and Dev #2_2 for the task #1 (Steps F5 and F6), and ends the process. When the task processor 121 completes the process of the task #1, the responder 122 transmits a completion notification of the process of the task #1 to the manager node 10-1.

In Step F3, the task processing status manager 105 of the manager node 10-1, which has received a process completion notification of the task #1 from the responder 122 of the agent node 10-2 (Agt #2), sets “Done” in the completion status (STATUS) of the task #1 (task ID: 001) of the task management information 202.

In Step F4, the task requester 102 of the manager node 10-1, which has received the process completion notification of the task #1 from the responder 122 of the agent node 10-2 (Agt #2), next requests the agent node 10-3 (Agt #3) to execute the task #2.

Here, it is assumed that abnormality occurs in the manager node 10-1 and the manager node 10-1 goes down.

In the meantime, the task processor 121 of the agent node 10-3 (Agt #3) starts processing the task #2 in response to the request from the manager node 10-1. Namely, the multiple commands included in the task #2 are sequentially executed in the agent node 10-3 (Agt #3).

The task processor 121 constructs devices Dev #31 and Dev #3_2 (Steps F7 and F8) for the task #2, and further constructs a device MirrorDev for the task #2 in Step F9. When the task processor 121 completes processing of the task #2, the responder 122 transmits a completion notification of the task #2 to the manager node 10-1.

However, since the manager node 10-1 is in the state of being down, the storage system 1 is in a state where a receiving counterpart that is to receive the completion notification of the task #2 from the agent node 10-3 is not present.

The following description assumes that the node 10-4 becomes a new manager node 10-4 (Mgr #4) in the above state. Hereinafter, the manager node 10-1 being down is sometimes referred to as the previous manager node 10-1.

The new manager node 10-4 starts the taking-over process from the previous manager node 10.

In Step F10, the task processing status manager 105 of the new manager node 10-4 accesses the store 20a and refers to information (the job management information 201, and the task management information 202) of the job #1 that has been executed in the previous manager node 10-1.

In Step F11, the task processing status manager 105 confirms that the task #1 has been completed but the task #2 has not been completed yet by referring to, for example, the task management information 202 and the job management information 201.

The task processing status manager 105 confirms the result of the process performed by the agent node 10-3.

In Step F12, the task processing status manager 105 of the new manager node 10-4 confirms the result of the process performed by the agent node 10-3.

In Step F13, the task processing status manager 105 confirms that the task #2 has been completed on the basis the information in the memory 12, such as the store 20a of the agent node 10-3.

In Step F14, the persistence processor 104 deletes the job #1 from the store 20a, for example.

In Step F15, the new manager node 10-4 notifies the user of the completion of generating a mirror volume, and ends the process.

(C) Effects:

As described above, in the storage system 1 of an example of the embodiment, the task creator 101 of the manager node 10 generates a single task by collecting multiple commands, and instructs an individual agent node 10 to execute commands in a unit of a task. An agent node 10 completes processing of multiple commands constituting a single task and responds the manager node 10 with the process result in a unit of a task.

This can reduce the times of communication (an amount of communication) between the manager node 10 and an agent node 10, so that load on the network 30 can be reduced.

Here, consideration will now be made in relation to an example of a case where: the number of nodes (node number) is N (one manager node and N−1 agent nodes) and M logical devices are constructed in each agent node at maximum; a single job consists of n tasks on average and a single task consists of a single command on average; and each node executes 1 commands.

In the above case, an average number of times of responding of the manager node in the traditional manner is represented by “Ave.(nl)”, which is obtained by responding when each of all the commands to be executed is completed.

In contrast, an average amount of calculation of the manager node 10-1 of the present storage system 1 is represented by “Ave.(n)” because the manager node 10-1 of the storage system 1 needs to respond to completion of all the tasks to be executed. Here, the storage system 1 needs not to issue a completion response in a unit of a command.

In cases where the agent node 10-3 detects that the task processor 121 has failed in execution of a command in own node 10, the roll-back processor 123 spontaneously carries out a roll-back process to regain the own node 10 to a status before executing the task. After the roll-back process is completed, the agent node 10-3 notifies the manager node 10-1 of the failure in executing the task.

This can reduce the times of communication (an amount of communication) between the manager node 10 and the agent node 10 even if execution of the task fails, so that load on the network 30 can be reduced. In addition, the agent node 10-3, which failed in execution of the task, can autonomously retain the status thereof to the normal status before executing the failed task rapidly, so that the reliability of the present storage system 1 can be enhanced.

The roll-back instructor 103 of the manager node 10-1 instructs the agent node 10-2, which executes another task include in the job the same as the task which the agent node 10-3 has failed in executing, to carry out a roll-back process of the task.

This regains the status of the agent node 10-2 to a status before executing the task, and consequently is capable of rapidly regaining the status of the present storage system 1 to a status before the execution of the job including the failed task, so that the reliability of the present storage system 1 can be enhanced.

In cases where the task processor 121 of the agent node 10 fails in executing an irreversible command, the agent node 10 refrains from notifying the manager node 10-1 of the failure in execution of the command. In other words, in cases where execution of an irreversible command fails, the responder 122 pretends to the manager node 10-1 that the execution of the irreversible command has succeeded.

This refrains from notifying the manager node 10-1 of the failure in executing the command, which results in that the manager node 10-1 regards the result of the execution of the command as success.

The persistence processor 104 stores the job management information 201 and the task management information 202 into the store 20a to make the information persistent. With this configuration, even if a manager node 10 goes down, failing over can be achieved because a new manager node 10 can take over the process by referring to the store 20a.

Once a process is started by an agent node, the process can be completed with being in a success or failure state even if the process goes into an abnormal state on its way without involving the manager node 10.

This can eliminate requirement of the manager node 10 for waiting due to an error process, so that the load on the manager node 10 can be abated. In addition, eliminating the requirement for waiting due to an error process, the manager node 10 can in turn execute a different process and can consequently enhance the process efficiency.

(D) Miscellaneous

The technique disclosed herein is not limited by the foregoing embodiment and various changes and modifications can be suggested without departing from the scope of the present embodiment. The respective configurations and processes of the embodiment can be selected, omitted, or combined according to the requirement.

For example, the number of nodes 10 included in the present storage system 1 is not limited to six. Alternatively, the present storage system 1 may include five or less or seven or more nodes 10.

In the above embodiment, the manager node 10-1 (task requester 102) transmits an executing module of the controlling program for an agent node along with a task executing request to the agent nodes 10-2 to 10-6. However, the present storage system 1 is not limited to this.

Alternatively, each node 10 may exert the functions as the agent node 10 by storing the controlling program for an agent node, which program causes a node 10 to function as an agent node 10, in a storage device such as the JBOD 20 and reading the program from the JBOD 20 and executing the program by the node 10.

The timing at which the persistence processor 104 stores information into the store 20a in the above embodiment can be variously modified.

Various changes and modifications from the above embodiment can be suggested without departing from the scope of the embodiment.

Those ordinary skilled in the art can carry out and produce the above embodiment by referring to the above disclosure.

According to an embodiment, in an information processing system using multiple control nodes, it is possible to abate the load on a control node (manager node) that manages the remaining controlling nodes.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus connected to a plurality of control nodes through a network, the information processing apparatus comprising:
a memory; and
a controller that is coupled to the memory and that controls the plurality of control nodes,
the controller being configured to:
transmit a task executing request to a first control node that is to execute a task including a plurality of processes and that is one of the plurality of control nodes; and
store management information that associates the task executing request transmitted to the first control node with a response result received from the first control node,
the task executing request comprising:
a command to execute the task;
a command to respond with a first notification indicating that the plurality of processes included in the task is normally completed;
a command to execute, when execution of at least one of the plurality of processes fails, a regaining process that regains statuses of one or more remaining processes successfully executed to statuses before being executed; and
a command to response, when execution of the regaining process is normally completed, a second notification indicating that the regaining process is normally completed.

2. The information processing apparatus according to claim 1, wherein the controller is further configured to:
create tasks one for each of a plurality of the first control nodes that are to execute the tasks, the tasks being based on a request input into the information processing apparatus, wherein
each of the tasks comprises a plurality of processes to be executed in a predetermined sequence by a single one of the plurality of first control nodes.

3. The information processing apparatus according to claim 2, wherein the task executing request further comprises a command to cause one or more of the plurality of first control nodes that execute other tasks based on a request same as a task including a failed process to regain statuses of the processes executed by the one or more first control node to statuses before being executed.

4. The information processing apparatus according to claim 1, wherein the task executing request further comprises a command to prohibit, when execution of an irreversible process fails, from responding with a failure of the irreversible process as the first notification, the irreversible process being unable to regain a status thereof to a status before being executed by disregarding a result obtained through the execution.

5. The information processing apparatus according to claim 1, wherein the controller is further configured to store the management information into a non-volatile storage device that the plurality of control nodes are accessible and that is external to the information processing apparatus.

6. An information processing system comprising:
a plurality of control nodes; and
a manager node that is connected to the plurality of control nodes through a network and that manages the plurality of control nodes, wherein
the manager node configured to:
transmit a task executing request to a first control node that is to execute a task including a plurality of processes and that is one of the plurality of control nodes, the task executing request requesting the first control node to execute the task;
store management information associating the task executing request transmitted to the first control node with a response result received from the first control node into a memory, and
the first control node is configured to:
execute the plurality processes included in the task;
respond with a first notification indicating that the plurality of processes included in the task is normally completed;
execute, when execution of at least one of the plurality of processes fails, a regaining process that regains statuses of one or more remaining processes successfully executed to statuses before being executed; and
response, when execution of the regaining process is normally completed, a second notification indicating that the regaining process is normally completed.

7. The information processing system according to claim 6, further comprising a task creator that creates tasks one for each of a plurality of the first control nodes that are to execute the tasks, the tasks being based on a request input into the manager node, wherein
each of the tasks comprises a plurality of processes to be executed in a predetermined sequence by a single one of the plurality of first control nodes.

8. The information processing system according to claim 7, further comprising a roll-back instructor that instructs one or more of the plurality of first control nodes that execute other tasks based on a request same as a task including a failed process to regain statuses of the processes executed by the one or more first control node to statuses before being executed.

9. The information processing system according to claim 6, further comprising a responder that prohibits, when execution of an irreversible process fails, from responding with a failure of the irreversible process as the first notification, the irreversible process being unable to regain a status thereof to a status before being executed by disregarding a result obtained through the execution.

10. The information processing system according to claim 6, further comprising a persistence processor that stores the management information into a non-volatile storage device that the plurality of control nodes are accessible and that is external to the manager node.

11. A non-transitory computer-readable recording medium having stored therein a control program to cause a processor included in an information processing apparatus that manages a plurality of control node to execute a process comprising:
transmitting a task executing request to a first control node that is to execute a task including a plurality of processes and that is one of the plurality of control nodes; and
storing management information that associates the task executing request transmitted to the first control node with a response result received from the first control node,
the task executing request comprising:
a command to execute the task;
a command to respond with a first notification indicating that the plurality of processes included in the task is normally completed;
a command to execute, when execution of at least one of the plurality of processes fails, a regaining process that regains statuses of one or more remaining processes successfully executed to statuses before being executed; and
a command to response, when execution of the regaining process is normally completed, a second notification indicating that the regaining process is normally completed.

12. The non-transitory computer-readable recording medium according to claim 11, wherein the process further comprising: creating tasks one for each of a plurality of the first control nodes that are to execute the tasks, the tasks being based on a request input into the information processing apparatus, wherein
each of the tasks comprises a plurality of processes to be executed in a predetermined sequence by a single one of the plurality of first control nodes.

13. The non-transitory computer-readable recording medium according to claim 12, wherein the process further comprising: further including, in the task executing request, a command to cause one or more of the plurality of first control nodes that execute other tasks based on a request same as a task including a failed process to regain statuses of the processes executed by the one or more first control node to statuses before being executed.

14. The non-transitory computer-readable recording medium according to claim 11, wherein the process further comprising: further including, in the task executing request, a command to prohibit, when execution of an irreversible process fails, from responding with a failure of the irreversible process as the first notification, the irreversible process being unable to regain a status thereof to a status before being executed by disregarding a result obtained through the execution.

15. The non-transitory computer-readable recording medium according to claim 11, the process further comprising: storing the management information into a non-volatile storage device that the plurality of control nodes are accessible and that is external to the information processing apparatus.
